(19) United States
(12) Patent Application Publication
(10) Pub. No.: US 2020/0126327 A1
(43) Pub. Date: Apr. 23, 2020

(54) METHOD AND APPARATUS FOR SERPENTINE BELT FAILURE DETECTION AND MITIGATION

(71) Applicant: GM GLOBAL TECHNOLOGY OPERATIONS LLC, DETROIT, MI (US)

(72) Inventors: David Gumpert, Farmington Hills (US); Joshua J. Sanchez, Sterling Heights, MI (US)

(21) Appl. No.: 16/166,396

(22) Filed: Oct. 22, 2018

(51) Int. Cl. G07C 5/08; F02D 29/06; F02D 29/04; F02B 67/06

(52) U.S. Cl. CPC G07C 5/0808; F02D 29/06; G07C 5/0833; F02B 67/06; G07C 5/0825; F02D 29/04

(57) ABSTRACT

The present application generally relates to a method and apparatus for detection of a serpentine belt failure and corresponding damage mitigation techniques after failure detection in a motor vehicle. In particular, the system is operative to determine an output of a first device, such as an alternator, activate a second device driven by the same serpentine belt in response to an unexpected value of the output of the first device and to predict a belt failure in response to the output of the second device having an unexpected value.

### BACKGROUND

The present disclosure relates to accessory drive systems, and more specifically to a serpentine belt failure monitor for accessory drive systems. More specifically, aspects of the present disclosure relate to systems, methods and devices for determining the failure and potential failure of a serpentine belt in a motor vehicle engine and the mitigation of damaging effects resulting therefrom.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Motor vehicles may include an internal combustion engine, an electric generator, and motor driven accessories, such as air conditioning. In addition, a hybrid vehicle may include an electric drive motor, and a rechargeable battery that powers the motor. The motor may transmit power and may charge the battery. An engagement may connect the motor with an engine crankshaft. The engagement may include an accessory drive system. The accessory drive system may include a serpentine belt engaged with the crankshaft and an input/output of the motor to transfer rotation therebetween.

Failure of a serpentine belt in an accessory drive system may result in mechanical damage to engine components. When a failure of a serpentine belt is suspected, preventative measures may be taken to reduce mechanical damage. Often however, the resulting performance of the component after a mechanical failure is the reason a belt failure is detected. It would be desirable to recognize a failure of a serpentine belt before mechanical damage occurs.

The above information disclosed in this background section is only for enhancement of understanding of the background of the invention and therefore it may contain information that does not form the prior art that is already known in this country to a person of ordinary skill in the art.

### SUMMARY

Disclosed herein are serpentine belt failure methods and systems and related control logic for detection of a serpentine belt failure and corresponding damage mitigation techniques after failure detection. The method and system are operative to identify root cause of multiple related failures in order to take preventative measures.

In accordance with an aspect of the present invention, an apparatus comprising a first device having a first output, a second device having a second output, a processor for generating a control signal indicative of a drive belt failure in response to the first output being less than a first expected value and the second output being less than a second expected value, and a user interface for generating a warning in response to the control signal.

In accordance with another aspect of the present invention an apparatus for predicting a serpentine belt failure comprising an alternator having an output voltage, an air conditioning compressor having an output pressure, a serpentine belt for driving the alternator and the air conditioning compressor wherein the serpentine belt is driven by an automotive engine, a processor for generating a control signal in response to the output voltage being less than an expected voltage and the output pressure being less than an expected output pressure, and a user interface for generating an alert indicative of a serpentine belt failure in response to the control signal.

In accordance with another aspect of the present invention a method for predicting a serpentine belt failure comprising determining a first output of a first engine accessory driven by a serpentine belt, determining a second output of a second engine accessory driven by the serpentine belt, generating a control signal in response to the first output being less than a first expected value and the second output being less than a second expected value, and generating a user notification in response to the control signal.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an exemplary application of the method and apparatus for detecting and mitigating serpentine belt failure in a motor vehicle according to an embodiment of the present disclosure.

FIG. 2 shows a block diagram illustrating an exemplary system for detecting and mitigating serpentine belt failure in a motor vehicle according to an embodiment of the present disclosure.

FIG. 3 shows a flowchart illustrating an exemplary method for detecting and mitigating serpentine belt failure according to another embodiment of the present disclosure.

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

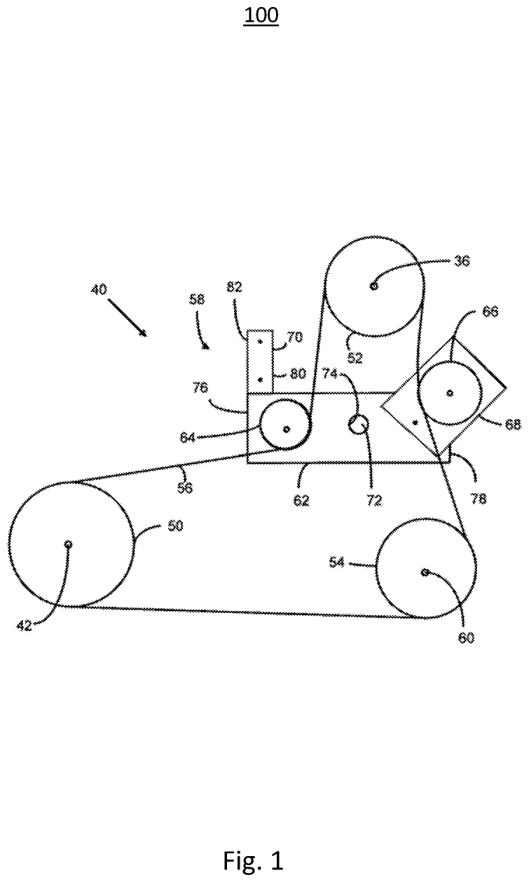

FIG. 1 schematically illustrates an exemplary application of the method and apparatus for detecting and mitigating serpentine belt failure in a motor vehicle 100 according to the present disclosure. In this exemplary embodiment, an accessory drive system 40 is presented and includes first, second, and third hubs 50, 52, 54, a serpentine belt 56, and a tensioner assembly 58. The first hub 50 is fixed to the crankshaft 42 for rotation therewith. The second hub 52 is fixed to an output of an alternator 36. The third hub 54 is fixed to an additional component 60 driven by the crankshaft 42 and/or the motor 36, such as a coolant pump. The belt 56 is engaged with the first, the second and the third hubs 50, 52, 54 to transfer rotation therebetween.

The tensioner assembly 58 includes a bracket 62, first and second belt tensioner hubs 64, 66, a friction damped rotary tensioner 68, a hydraulic strut tensioner 70, and a pivot coupling 72. The bracket 62 includes an aperture 74 located between first and second ends 76, 78 thereof. The first and the second belt tensioner hubs 64, 66 is rotatably coupled to the first and the second ends 76, 78, respectively. More specifically, the second belt tensioner hub 66 is coupled to the friction damped rotary tensioner 68 which is coupled to the second end 78. The hydraulic strut tensioner 70 includes a first end 80 coupled to the first end 76 of the bracket 62 and a second end 82 coupled to the engine 22.

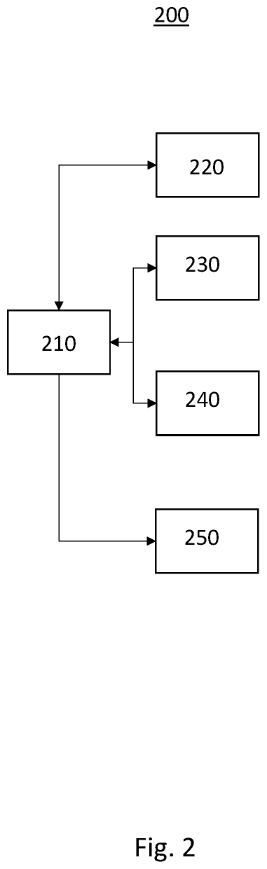

Turning now to FIG. 2, a block diagram illustrating an exemplary system for detecting and mitigating serpentine belt failure in a motor vehicle 200 is shown. In this exemplary embodiment, the system 200 comprises an alternator 220, an air conditioning (AC) compressor 230, a coolant pump 240, a system processor 210 and a user interface 250. The exemplary system is operative to detect serpentine belt failure to take fail soft action and/or provide user notification. The addresses this outcome by observing the outputs of multiple belt driven systems, such as the alternator 220 output, coolant temperature, and AC pressure among others. Each of these systems can fail individually, but they are unlikely to fail together unless the serpentine belt fails.

In an exemplary embodiment, the system processor 210 is operative to monitor the output of a device with a rapidly changing output in the event of a serpentine belt failure, such as the alternator 220. In the event of a serpentine belt failure, the voltage output of the alternator 220 will immediately drop to zero. In this instance, either the alternator 220 has failed, or the serpentine belt has failed. The system processor 210 is then operative to check the output of another fast response device, such as pressure generated by the AC compressor 230. If the AC compressor pressure has dropped, a serpentine belt failure is likely. It is unlikely that both the alternator 220 and the AC compressor 230 have stopped functioning simultaneously, so the drive belt failure is probable. The system processor is then operative to generate an indication on the user interface 250. The user interface may include a warning light on the dashboard, a message on a video screen inside the cabin of the vehicle, or an audible alarm, such as a chime to notify a driver of the failure. In addition or alternatively, the system processor 210 may engage a preventative measure in order to reduce the probability or avoid mechanical damage. For example, if a serpentine belt failure is suspected, the system processor 210 may stop the engine to prevent thermal damage resulting from an inactive coolant pump 240. Alternatively, the engine may be reconfigured to operate at a greatly reduced output, such as running only on two cylinders in order to reduce thermal output and reduce the probability of mechanical damage.

The system processor 210 is operative to monitor the output of components whose output will respond quickly to belt failure in applications where the belt drives multiple systems. If one fast response system fails and another fast response system is inactive, the system processor may temporarily enable that second system. If the second system does not respond, the system processor 210 may then predict the impending failure of slower response systems. The system processor 210 may then take fail soft action for those systems before damage occurs. A change in the performance one system might be quick to identify, but other systems may react more slowly. Correlating ‘fast’ failures, such as AC pressure and alternator output, allows for fail soft action before ‘slow’ failures, such as coolant temperature become detectable.

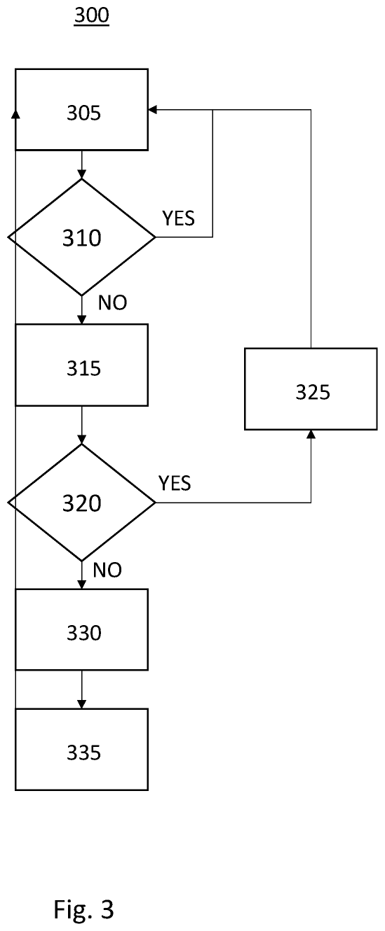

Turning now to FIG. 3, a flowchart illustrating an exemplary method for detecting and mitigating serpentine belt failure in a motor vehicle 300 is shown. The method 300 may be performed by a processor in a motor vehicle. The exemplary method is first operative to monitor the output of a first system within an accessory drive system 305, such as an alternator voltage output. The method is then operative to determine if the output of the first system is within an expected operating output range 310. If the output is within the expected range, the method then returns to monitoring the output of the first system 305.

If the output of the first system is not within the expected operating output range, the method is then operative to monitor the output of a second system 315, such as the pressure of an air conditioning compressor. The method then determines if the output of the second system is within an expected operating output range 320. If the output of the second system is within the expected operating output range, the method may optionally provide a driver notification or the like of a failure of the first system 325. The method then returns to monitoring the output of the first system 305.

If the output of the second system is not within the expected operating output range, a serpentine belt failure is predicted 330. In the event of a serpentine belt failure prediction, a failure action is performed 335. This failure action may include a driver notification, a damage control action, such as reduction of engine power, reduced number of active cylinders, or shutdown of the vehicle engine. Alternatively, the failure action may involve close monitoring of a coolant temperature with constant notification to a driver of upcoming engine shutdown. This may provide sufficient time for a driver to move the vehicle to a safe area before engine shutdown occurs to prevent mechanical damage. The method is then operative to return to monitoring the output of the first system 305.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. An apparatus comprising:
a first device having a first output, wherein the first device is an alternator and the first output is a voltage;
a second device having a second output, wherein the second device is an air conditioning compressor and the second output is a pressure and wherein the second device is activated in response to the first device having an output less than the first expected value;
a processor for generating a control signal indicative of a drive belt failure in response to the first output being less than a first expected value and the second output being less than a second expected value; and
a user interface for generating a warning in response to the control signal.

2. (canceled)

3. (canceled)

4. The apparatus of claim 1 wherein the first device and the second device are driven by a serpentine belt.

5. The apparatus of claim 1 wherein the processor is further operative to deactivate a third device in response to the first output being less than the first expected value and the second output being less than the second expected value.

6. The apparatus of claim 1 wherein the second device is activated in response to the first device having an output less than the first expected value.

7. The apparatus of claim 1 wherein the user interface is a dashboard light within a vehicle cabin.

8. An apparatus for predicting a serpentine belt failure comprising:
an alternator having an output voltage;
an air conditioning compressor having an output pressure;
a serpentine belt for driving the alternator and the air conditioning compressor wherein the serpentine belt is driven by an automotive engine;
a processor for generating a control signal in response to the output voltage being less than an expected voltage and the output pressure being less than an expected output pressure, wherein the air conditioning compressor is activated in response to the output voltage being less than an expected voltage; and
a user interface for generating an alert indicative of a serpentine belt failure in response to the control signal.

9. The apparatus of claim 8 wherein the processor is further operative to deactivate the automotive engine in response to the output voltage being less than an expected voltage and the output pressure being less than an expected output pressure.

10. (canceled)

11. The apparatus of claim 8 wherein the user interface is a warning light within a vehicle cabin.

12. The apparatus of claim 8 wherein the user interface is an audible alert.

13. The apparatus of claim 8 wherein the automotive engine is run in a low power mode in response to the output voltage being less than an expected voltage and the output pressure being less than an expected output pressure.

14. A method comprising:
determining a first output of a first engine accessory driven by a serpentine belt wherein the first engine accessory is an alternator;
determining a second output of a second engine accessory driven by the serpentine belt, wherein the second engine accessory is an air conditioning compressor and wherein the second engine accessory is activated in response to the first output being less than the first expected value; and
generating a control signal in response to the first output being less than a first expected value and the second output being less than a second expected value; and
generating a user notification in response to the control signal.

15. The method of claim 14 further comprising changing an engine performance parameter in response to the control signal.

16. (canceled)

17. (canceled)

18. The method of claim 14 wherein the first output being less than the first expected value and the second output being less than a second expected value is indicative of a failure of the serpentine belt.

19. The method of claim 14 wherein the user notification is a light within a vehicle cabin.

20. The method of claim 14 wherein the user notification is an audible alarm within a vehicle cabin.
